(19) United States
(12) Patent Application Publication
(10) Pub. No.: US 2024/0320086 A1
(43) Pub. Date: Sep. 26, 2024

(54) ERROR DETECTION FOR ENCRYPTION OR DECRYPTION KEYS

(71) Applicant: STMicroelectronics International N.V., Geneva (CH)

(72) Inventors: Pierre-Alexandre BLANC, Evere (BE); Gilles VAN ASSCHE, Woluwe-St-Lambert (BE)

(73) Assignee: STMicroelectronics International N.V., Geneva (CH)

(21) Appl. No.: 18/612,421

(22) Filed: Mar. 21, 2024

(30) Foreign Application Priority Data
Mar. 24, 2023 (FR) 2302829

(51) Int. Cl. G06F 11/10; G06F 21/60

(52) U.S. Cl. CPC G06F 11/1004; G06F 11/1068; G06F 21/602

(57) ABSTRACT

The present description concerns a method of checking a first data element, executed by an electronic device comprising a processor and a memory, wherein said first data element is not stored in said memory and is divided in N second data elements independent from the first data element, each second data element being stored in said memory, and a result of an application of a XOR function to the N second elements being equal to the first data element, wherein an image of the first data element by a CRC function linear with respect to the XOR function is stored in said memory, and said method comprising a step, executed by said processor, of checking if said image of the first data element by said CRC function is equal to an application of the XOR function to the images of N second elements by said CRC function.

### BACKGROUND

### Technical Field

The present disclosure generally concerns the computerized processing of critical and/or secret data, and, more particularly, the computational security of the processing of such data. The present disclosure more particularly relates to the checking and detection of errors of such a data element, such as an encryption and/or decryption key used in computer-based data storage, communication, or other computing functionalities.

### Description of the Related Art

Different techniques of securization of secret and/or critical data are currently used. Data encryption is one of them, and consists of the application of one or a plurality of encryption algorithms to data. Many encryption algorithms use encryption and/or decryption keys.

Before using an encryption and/or decryption key, it is common to check whether the encryption key stored in the memory is correct, that is, exhibits no error.

It would be desirable to be able to at least partly improve certain aspects of checking and/or error detection methods.

### BRIEF SUMMARY

There exists a need for a more efficient securization of critical and/or secret data.

There exists a need for a more efficient securization of encryption and/or decryption keys.

An embodiment overcomes all or part of the disadvantages of methods of checking and/or of detection of errors of a data element.

An embodiment provides a more secure method of checking and/or of detection of errors of a data element.

An embodiment provides methods of checking and/or of detection of errors of a data element which do not make said data element accessible.

An embodiment provides methods of checking and/or of detection of errors of a data element having a Boolean decomposition.

An embodiment provides a method of checking a first data element, executed by an electronic device comprising a processor and a memory, wherein said first data element is not stored in said memory and is divided in N second data elements independent from the first data element, i varying from 1 to N, each second data element being stored in said memory, and a result of an application of a XOR logic function to the N second elements being equal to the first data element,
wherein an image of the first data element by a cyclic redundancy check function linear with respect to the XOR logic function is stored in said memory, and
said method comprising a step, executed by said processor, of checking if said image of the first data element by said cyclic redundancy check function is equal to an application of the XOR logic function to the images of N second elements by said cyclic redundancy check function.

Another embodiment provides an electronic device comprising a processor and a memory, and adapted to implementing a method of checking a first data element, wherein said first data element is not stored in said memory and is divided in N second data elements independent from the first data element, i varying from 1 to N, each second data element being stored in said memory, and a result of an application of a XOR logic function to the N second elements being equal to the first data element,
wherein an image of the first data element by a cyclic redundancy check function linear with respect to the XOR logic function is stored in said memory, and
said method comprising a step, executed by said processor, of checking if said image of the first data element by said cyclic redundancy check function is equal to an application of the XOR logic function to the images of N second elements by said cyclic redundancy check function.

According to an embodiment, wherein at least one of said N second data elements is obtained randomly.

According to an embodiment, the cyclic redundancy check function is a cyclic redundancy check function of polynomial type.

According to an embodiment, the cyclic redundancy check function is a cyclic redundancy check function of polynomial type used in the algorithm known under trade name CRC32.

According to an embodiment, integer N is greater than or equal to two.

According to an embodiment, the first data element is an encryption and/or decryption key.

According to an embodiment, said first data element is a key capable of being used in different types of encryption algorithm such as AES.

According to an embodiment, said first data element is a data element capable of being used in different types of encryption algorithm such as elliptic curve encryption algorithms, signature algorithms such as those known under trade name CRYSTALS-Dilithium, or key encapsulation algorithm known under trade name Kyber.

Another embodiment provides a method of using first data element comprising the method of checking said first data element described previously.

### BRIEF DESCRIPTION OF THE SEVERAL VIEWS OF THE DRAWINGS

The foregoing features and advantages, as well as others, will be described in detail in the rest of the disclosure of specific embodiments given by way of illustration and not limitation with reference to the accompanying drawings, in which:

FIG. 1 very schematically shows in the form of blocks an example of an electronic device adapted to implementing the embodiments described in relation with FIGS. 2 to 4;

FIG. 2 very schematically shows in the form of blocks an example of Boolean decomposition of a data element;

FIG. 3 very schematically shows in the form of blocks a cyclic redundancy check function;

FIG. 4 shows a block diagram illustrating an implementation mode of a method of checking an encryption and/or decryption key; and

FIG. 5 shows a block diagram illustrating an implementation mode of a method of using an encryption and/or decryption key.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front,” “back,” “top,” “bottom,” “left,” “right,” etc., or relative positions, such as terms “above,” “under,” “upper,” “lower,” etc., or to terms qualifying directions, such as terms “horizontal,” “vertical,” etc., it is referred, unless specified otherwise, to the orientation of the drawings.

Unless specified otherwise, the expressions “about,” “approximately,” “substantially,” and “in the order of” signify plus or minus 10%, preferably of plus or minus 5%.

The embodiments described hereafter relate to the checking and/or the detection of errors of a data element, for example, before its use or its storage in a memory. This more precisely concerns the checking and/or the detection of errors of a critical and/or secret data element, such as an encryption and/or decryption key.

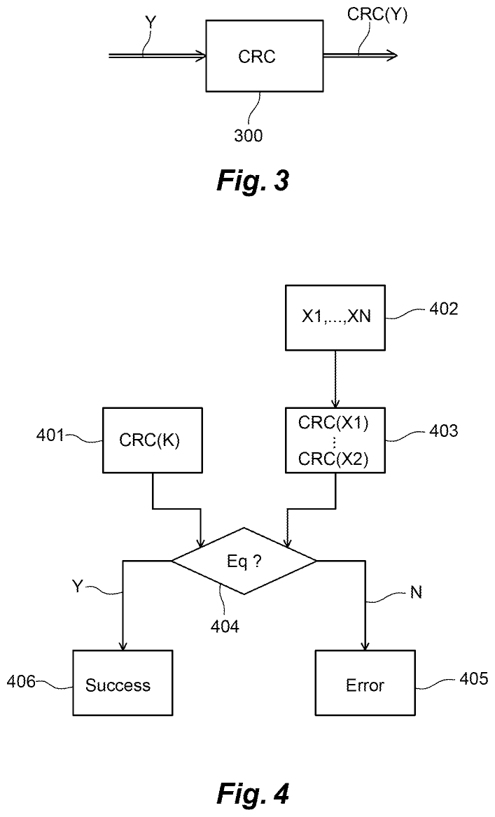

The embodiments described hereafter more particularly concern a checking method, or error detection method, where the data element which is checked is never made accessible. For this purpose, the checking method uses a Boolean decomposition of the data element to be checked and a cyclic redundancy check function. The Boolean decomposition of a data element is described in details in relation with FIG. 2. Further, a detailed description of a cyclic redundancy check function is made in relation with FIG. 3. The actual checking method is described in relation with FIG. 4.

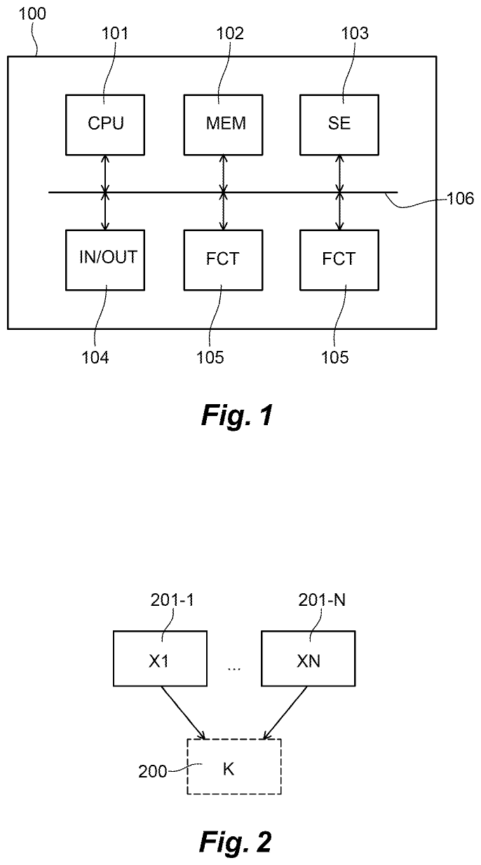

FIG. 1 is a block diagram very schematically showing an architecture of an example of an electronic device 100 adapted to executing the implementation mode of the method of checking, or the method of detection of errors, of a data element described hereafter.

Electronic device 100 comprises a processor 101 (CPU) adapted to implementing different processings of data elements stored in memories and/or supplied by other circuits of device 100.

Electronic device 100 further comprises different types of memories 102 (MEM), among which, for example, a non-volatile memory, a volatile memory 103, and/or a ROM 104. Each memory 102 is adapted to storing different types of data elements.

Electronic device 100 further comprises, for example, a secure element 103 (SE) adapted to processing critical and/or secret data. Secure element 103 may comprise its own processor(s), its own memory or memories, etc.

There are called, in the rest of the disclosure, critical data elements and secret data elements, data elements having a content which is not intended to be public, and, thus, the access to which is restricted to certain specific persons and/or circuits. An encryption and/or decryption key is considered as being a critical and/or secret data element since such a key enables to encode critical and/or secret data, and/or to decode encrypted data elements.

Electronic device 100 may further comprise interface circuits 104 (IO/OUT) adapted to sending and/or to receiving data elements originating from the outside of device 100. Interface circuits 104 may further be adapted to implementing a display of data elements, for example, a display screen.

Electronic device 100 further comprises different circuits 105 (FCT) adapted to carrying out different functions. As an example, circuits 105 may comprise measurement circuits, data conversion circuits, circuits for controlling electrical or electromechanical equipment, etc.

Electronic device 100 further comprises one or a plurality of data buses 106 adapted to transferring data between its different components.

FIG. 2 very schematically illustrates in the form of blocks an example of Boolean decomposition of a data element 200 (k).

Data element 200, called data element k in the rest of the disclosure, is a digital data element. Data element k may be, for example, a critical and/or secret data element adapted to being used by a device of the type of the device 100 described in relation with FIG. 1. According to an embodiment, data element k is an encryption and/or decryption key. According to an example of embodiment, data element k is an encryption and/or decryption key used in an encryption algorithm of AES (Advanced Encryption Standard) type. According to another example of embodiment, data element k is a data element used in different types of encryption algorithms such as, for example, elliptic curve encryption algorithms, signature algorithms such as, for example, those known under trade name CRYSTALS-Dilithium, or key encapsulation algorithms such as, for example, those known under trade name Kyber.

Data element k is, for example, obtained by a random number generator comprised in device 100, for example constituted by one of functions of circuits 105. According to another example, data element k is generated by processor 101 or by secure element 103.

Data element k exhibits a Boolean decomposition into N data elements Xi, N being an integer and i being an integer varying from 1 to N. In other words, data element k is decomposed into N data elements 201-1 (X1), . . . , 201-N (XN), called data elements X1, . . . , XN in the rest of the disclosure. The Boolean decomposition uses the XOR logic function. Data element k is linked to data elements X1, . . . , XN by the following mathematical formula A:

$$k = {XOR}_{i = 1}^{N} ( X i )$$

where XORᵢ₌₁^{N} represents an XOR logic function with N inputs.

An equivalent notation of formula A given previously is the following:

$$k = X 1 xor X 2 xor … xor XN$$

where xor represents the XOR logic function with two inputs.

According to an embodiment, data element k is not stored in a memory 102 of the electronic device 1000, but only data elements X1, . . . , XN are stored in one or a plurality of memories 102 of the electronic device 100.

Further, according to an embodiment, data elements X1 to XN are all independent from data element k. In other words, data elements X1 to XN are only linked to data element k by the previously-given mathematical formula A.

According to an example, the decomposition of data element k is obtained by using a random data element generation function. N−1 data elements X1 to XN−1 are, for example, randomly generated, and the last data element XN is obtained by applying formula A.

There exists a multitude of possible Boolean decompositions for a data element. It is thus possible to change the decomposition data elements, for example if data elements X1, . . . , XN have become accessible. It is sufficient, for example, to generate N−1 new random data elements and to determine the last one by applying formula A.

FIG. 3 very schematically illustrates in the form of blocks an implementation mode of a function 300 (CRC).

Function 300 is cyclic redundancy check function (CRC) adapted to receiving, as an input, a data element Y and to delivering, as an output, a data element CRC(Y). Such a function is used to detect errors. Function CRC is, for example, executed by processor 101, by secure element 103 or by one of the functions of circuits 105.

Further, according to an embodiment, function 300 is a linear function with respect to the XOR logic function. In other words, the following mathematical relation is verified:

$$CRC ( Y xor Z ) = CRC ( Y ) xor CRC ( Z )$$

where Y and Z are both data elements.

Cyclic redundancy check functions are known by those skilled in the art. According to an example, function 300, may be, for example, a cyclic redundancy check function of polynomial type. According to an example, the function used in the algorithm known under trade name CRC32.

FIG. 4 is a block diagram showing an implementation mode of a method of checking, or of a method of detection of errors, of the data element k defined in relation with FIG. 2 and using the function 300 described in relation with FIG. 3.

The method of checking data element k enables to detect transmission, combination and/or algorithm application errors. The checking method is for example used before the use of data element k.

This checking method is adapted to being implemented by the device 100 described in relation with FIG. 1, or by a device of the type of device 100.

At an initialization step 401 (CRC(k)), a data element CRC(k) representing the image of data element k by function 300 is obtained by processor 101, by secure element 103 or by one of the functions of circuits 105. According to an embodiment, image CRC(k) is computed and stored in a memory of device 100, but data element k itself is not stored in the memory. This step may be implemented from as soon as the generation of data element k.

At another initialization step 402 (X1, . . . , XN), the Boolean decomposition of data element k into data elements X1 to XN is obtained, for example, by using the technique described in relation with FIG. 2, meaning by using processor 101, secure element 103 or one of the functions of circuits 105. According to an embodiment, data elements X1 to XN are all stored in one or a plurality of memories of device 100. This step may, also, be implemented from as soon as the generation of data element k.

At a step 403 (CRC(X1), . . . , CRC(XN)), subsequent to step 402, data elements CRC(X1) to CRC(XN) representing the images of data elements X1 to XN by function 300 are obtained by processor 101, by secure element 103 or by one of the functions of circuits 105. According to a preferred embodiment, images CRC(X1) to CRC(XN) are computed and stored, temporarily, in a memory 102 of device 100. According to a variant, this step may be implemented from as soon as the generation of data element k, like step 402, and images CRC(X1) to CRC(XN) may be stored for a long time period in a memory of device 100.

At a step 404 (Eq?), subsequent to steps 401 and 403, the following mathematical formula B is checked by processor 101, by secure element 103 or by one of the functions of circuits 105.:

$$C R C ( k ) = {XOR}_{i = 1}^{N} ( C R C ( {X}_{i} ) )$$

An equivalent notation of formula B given previously is the following:

$$CRC ( k ) = CRC ( X 1 ) xor CRC ( X2 ) xor … xor CRC ( X N )$$

To perform these checkings, the data elements obtained at steps 401 to 403 are used.

If formula B is verified (output Y) then the next step is a step 405 (Success). Otherwise (output N), the next step is a step 406 (Error).

At step 405, formula B has been verified, it is thus considered that data elements X1 to XN are correct and effectively enable to obtain data element k by using the previously-described formula A, by using processor 101, secure element 103 or one of the functions of circuits 105. Data elements X1 to XN may be used in linear computations with respect to the XOR operation instead of data element k, such as encryption computations.

At step 406, formula B is not verified. The decomposition of data element k into data elements X1 to XN thus exhibits errors, and data elements X1 to XN thus cannot be used to obtain data element k by using formula A.

An advantage of this checking method is that it is faster to implement than a conventional checking method, such as a checking method using complex encryption computations such as AES or computations on elliptic curves.

Another advantage of this method is that the risk for a data element k which is verified to be accessible is much lower than with a conventional checking method. Indeed, data element k is not stored in the memory, and data elements X1 to XN are all independent from data element k. One should thus have access to all the elements X1 to XN to obtain data element k.

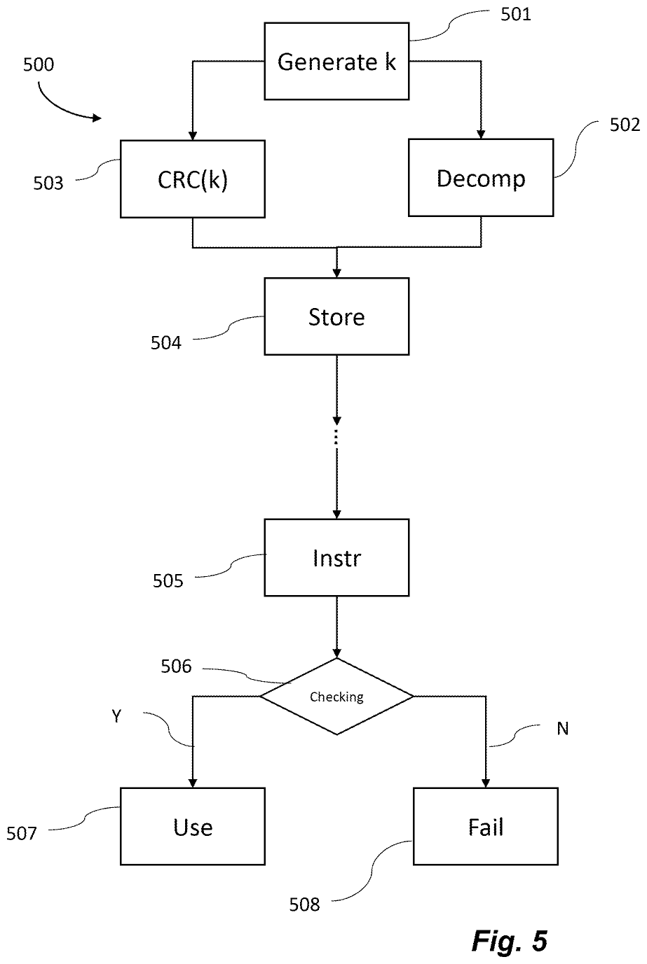

FIG. 5 is a bloc diagram illustrating a method of using data element k disclosed in relation with FIG. 2. This method is executed by an electronic device D of type of electronic device 100 described in relation with FIG. 1. More particularly, electronic device D comprises at least a processor P and a memory M. Processor P can be any type of processor described in relation with FIG. 1, and memory M can be any type of memory described in relation with FIG. 1.

At an initial step 501 (Generate k), executed by processor P, data element k is generated. According to an embodiment, data element k is a critical and/or secret data, such as an encryption and/or decryption key as described in relation with FIG. 2, that must not be stored in memory.

At a step 502 (Decomp), following step 501, executed by processor P, a Boolean decomposition of data element k is prepared. In other words, the N independent data element X1, . . . XN, described in relation with FIG. 2, are generated as described in relation with FIG. 2.

At a step 503 (CRC(k)), following step 501, executed by processor P, an image CRC(k) of the data element k by a cyclic redundancy check function, such as function 300 described in relation with FIG. 3, is calculated using data element k.

According to a variant, step 503 follows step 502, and the image CRC(k) is calculated by using data elements X1, . . . , XN, and not directly data element k.

At a step 504 (Store), following steps 502 and 503, executed by processor P and memory M, data elements X1, . . . , XN and the image CRC(k) are all stored in the memory M. All existing copy of data element k are deleted for safety purposes.

At a step 505 (Instr), following step 504, executed by processor P, the processor P receives an instruction requesting the use of data element k. If data element k is an encryption and/or decryption key, the instruction may be an encryption and/or decryption instruction. In order to execute the instruction, processor P has only access to data element X1, . . . , XN and not to data element k.

At a step 506 (Checking), following step 505, executed by processor P, processor P execute method of checking described in relation with FIG. 4, to verify if all data element X1, . . . , XN have been correctly retrieved in memory M, and if all data element X1, . . . , XN have not been modified. If method of checking described in relation with FIG. 4 is a success (output Y) then the next step is a step 507 (Use). Otherwise (output N), the next step is a step 508 (Fail).

At step 507, executed by processor P, method of FIG. 4 has proven that all data element X1, . . . , XN are correct, processor P can execute the instruction received in step 505 by using data element X1, . . . , XN.

At step 508, executed by processor P, method of FIG. 4 has proven that at least one data element amongst data element X1, . . . , XN is not correct, processor P can not execute the instruction it received in step 505.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

Method of checking a first data element (k), executed by an electronic device (100) may be summarized as including a processor (101) and a memory (102), wherein said first data element (k) is not stored in said memory and is divided in N second data elements (X1, . . . , XN) independent from the first data element (k), each second data element (X1, . . . , XN) being stored in said memory, and a result of an application of a XOR logic function to the N second elements (X1, . . . , XN) being equal to the first data element (k), wherein an image of the first data element (k) by a cyclic redundancy check function (300) linear with respect to the XOR logic function is stored in said memory, and said method including a step, executed by said processor, of checking if said image of the first data element (k) by said cyclic redundancy check function (300) is equal to an application of the XOR logic function to the images of N second elements (X1, . . . , XN) by said cyclic redundancy check function (300).

Electronic device may be summarized as including a processor (101) and a memory (102), and adapted to implementing a method of checking a first data element (k), wherein said first data element (k) is not stored in said memory and is divided in N second data elements (X1, . . . , XN) independent from the first data element (k), each second data element (X1, . . . , XN) being stored in said memory, and a result of an application of a XOR logic function to the N second elements (X1, . . . , XN) being equal to the first data element (k), wherein an image of the first data element (k) by a cyclic redundancy check function (300) linear with respect to the XOR logic function is stored in said memory, and said method including a step, executed by said processor, of checking if said image of the first data element (k) by said cyclic redundancy check function (300) is equal to an application of the XOR logic function to the images of N second elements (X1, . . . , XN) by said cyclic redundancy check function (300).

At least one of said N second data elements (X1, . . . , XN) may be obtained randomly.

The cyclic redundancy check function (300) may be a cyclic redundancy check function of polynomial type.

The cyclic redundancy check function (300) may be a cyclic redundancy check function of polynomial type used in the algorithm known under trade name CRC32.

Integer N may be greater than or equal to two.

The first data element (k) may be an encryption and/or decryption key.

Said first data element (k) may be a key capable of being used in different types of encryption algorithm such as AES.

Said first data element (k) may be a data element capable of being used in different types of encryption algorithm such as elliptic curve encryption algorithms, signature algorithms such as those known under trade name CRYSTALS-Dilithium, or key encapsulation algorithm known under trade name Kyber.

Method of using first data element (k) may include the method of checking said first data element (k).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method for error detection of an encryption or decryption key, executed by an electronic device comprising a processor and a memory, wherein a first data element corresponding to the encryption or decryption key is not stored and made accessible in the memory and is divided in N second data elements independent from the first data element, each second data element being stored in the memory, and a result of an application of a XOR logic function to the N second elements being equal to the first data element,
wherein an image of the first data element by a cyclic redundancy check function linear with respect to the XOR logic function is stored in the memory, and
wherein the method comprises determining, by at least the processor, whether the image of the first data element by the cyclic redundancy check function is equal to an application of the XOR logic function to the images of N second elements by the cyclic redundancy check function.

2. The method according to claim 1, wherein at least one of the N second data elements is obtained randomly.

3. The method according to claim 1, wherein the cyclic redundancy check function is a cyclic redundancy check function of polynomial type.

4. The method according to claim 3, wherein the cyclic redundancy check function is a cyclic redundancy check function of polynomial type used in an algorithm known under trade name CRC32.

5. The method according to claim 1, wherein integer N is greater than or equal to two.

6. The method according to claim 1, wherein the first data element is a key capable of being used in one or more types of encryption algorithms including AES.

7. The method according to claim 1, wherein the first data element is a data element capable of being used in encryption methods including at least one of elliptic curve encryption algorithms, signature algorithms, or key encapsulation algorithms.

8. An electronic device comprising a processor and a memory, and adapted to implementing a method for error detection of an encryption or decryption key, wherein a first data element corresponding to the encryption or decryption key is not stored and made accessible in the memory and is divided in N second data elements independent from the first data element, each second data element being stored in the memory, and a result of an application of a XOR logic function to the N second elements being equal to the first data element,
wherein an image of the first data element by a cyclic redundancy check function linear with respect to the XOR logic function is stored in the memory, and
wherein the method comprises determining, by at least the processor, whether the image of the first data element by the cyclic redundancy check function is equal to an application of the XOR logic function to the images of N second elements by the cyclic redundancy check function.

9. The device according to claim 8, wherein at least one of the N second data elements is obtained randomly.

10. The device according to claim 8, wherein the cyclic redundancy check function is a cyclic redundancy check function of polynomial type.

11. The device according to claim 10, wherein the cyclic redundancy check function is a cyclic redundancy check function of polynomial type used in an algorithm known under trade name CRC32.

12. The device according to claim 8, wherein integer N is greater than or equal to two.

13. The device according to claim 8, wherein the first data element is a key capable of being used in one or more types of encryption algorithms including AES.

14. The device according to claim 8, wherein the first data element is a data element capable of being used in encryption methods including at least one of elliptic curve encryption algorithms, signature algorithms, or key encapsulation algorithms.

15. A non-transitory computer-readable medium storing content that cause one or more processors to implement a method for error detection of a data element, wherein a first data element is not stored and made accessible in the computer-readable medium and is divided in N second data elements independent from the first data element, each second data element being stored in the computer-readable medium, and a result of an application of a XOR logic function to the N second elements being equal to the first data element,
wherein an image of the first data element by a cyclic redundancy check function linear with respect to the XOR logic function is stored in the computer-readable medium, and
wherein the method comprises determining, by the one or more processors, whether the image of the first data element by the cyclic redundancy check function is equal to an application of the XOR logic function to the images of N second elements by the cyclic redundancy check function.

16. The computer-readable medium according to claim 15, wherein at least one of the N second data elements is obtained randomly.

17. The computer-readable medium according to claim 15, wherein the cyclic redundancy check function is a cyclic redundancy check function of polynomial type.

18. The computer-readable medium according to claim 17, wherein the cyclic redundancy check function is a cyclic redundancy check function of polynomial type used in an algorithm known under trade name CRC32.

19. The computer-readable medium according to claim 15, wherein the first data element is an encryption or decryption key.

20. The computer-readable medium according to claim 19, wherein the first data element is a key capable of being used in one or more types of encryption algorithms including AES.
